(19) United States
(12) Patent Application Publication
(10) Pub. No.: US 2007/0283281 A1
(43) Pub. Date: Dec. 6, 2007

(54) Portlet Communication Arrangements, Portlet Containers, Methods of Communicating Between Portlets, and Methods of Managing Portlet Communication Arrangements Within a Portal

(75) Inventors: John Ainsworth, Mount Sinai, NY (US); Eric Michael Bernstein, Lafayette Hill, PA (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 11/691,075

(22) Filed: Mar. 26, 2007

Related U.S. Application Data
(60) Provisional application No. 60/804,065, filed on Jun. 6, 2006.

(51) Int. Cl. G06F 3/00

(52) U.S. Cl. 715/760

(57) ABSTRACT

A portlet communication arrangement includes a first portlet associated with a first application, and a second portlet associated with a second application which is different than the first application. The portlet communication arrangement also includes a mapping system for allowing the first portlet to communicate with the second portlet and for allowing the second portlet to communicate with the first portlet. For example, the first portlet may include a first parameter associated with a particular type of data, the second portlet may include a second parameter associated with the particular type of data, and the mapping system may include a database that includes the first parameter, the second parameter, and a shared parameter namespace associated with the particular type of data. Moreover, the mapping system may be configured to map the first parameter and the second parameter to the shared parameter namespace to allow the first portlet to communicate with the second portlet and to allow the second portlet to communicate with the first portlet.

### CROSS-REFERENCE TO RELATED APPLICATIONS

The present application is a non-provisional patent application which claims priority from and is based on U.S. Provisional Patent Application Ser. No. 60/804,065, the disclosure of which is incorporated herein by reference in its entirety.

### BACKGROUND OF THE INVENTION

1. Field of the Invention

The present invention relates generally to portlet communication arrangements, portal containers, methods of communicating between portlets, and methods of managing portlet communication arrangements within a portal. In particular, the present invention is directed towards arrangements and methods in which portlets associated with different applications are able to indirectly communicate with each other via a mapping system.

2. Description of Related Art

Known portals provide a hosting environment for different portlets and a means for aggregating portlets through a web page. Portals are considered to be the standard browser-based interface to enterprise information. Portals generally have a robust-application framework and deliver ready access to information along with the ability to aggregate applications within the enterprise. In particular, portals allow for the aggregation of applications and content into a single view or web page, which facilitates intelligent decision making. For example, known portals may allow a user to simultaneously view their email, inventory level indicator, call-center issue queues, today's industry news headlines, and real-time charts of product sales on the same web page, such that the user does not need to open or shift between multiple, different applications.

Known portlets may be a reusable, pluggable, Java-based web component displayed by itself or with other portlets in a portal web application. Portlets allow users to save design, development, and testing time by taking advantage of services provided by the portal. Known portlets provide a presentation layer to information systems, and are placed on a web page, process user requests, and generate dynamic content. Web clients interact with portlets through a request/response paradigm implemented by the portal. Generally, users interact with content produced by portlets, e.g., by following links or submitting forms, resulting in portlet actions being received by the portal, which then forwards to the portlet(s) targeted by the user's interactions.

Known portlet containers may provide a runtime environment for portlets. The portlet container may contain portlets and may manage their lifecycle, e.g., instantiating portlets, processing requests on portlets, and destroying portlets. In general, when a user accesses a portal page, (1) the portal receives a request from a client; (2) the portal determines whether the request contains an action targeted to any of the portlets associated with the portal page; (3) when the request contains an action, the portal calls the portlet container to invoke the targeted portlet to perform the action; (4) the portlet container invokes portlets on the page to generate content fragments; and (5) the portal aggregates the content fragments of the portlets on the page and sends the portal page back to the client.

In general, a portal includes a plurality of portlets, and such portlets may be created by different vendors and may provide related functionality. Nevertheless, even though the portlets may provide related functionality, such portlets cannot communicate with each other, e.g., cannot share the same data.

### SUMMARY OF THE INVENTION

Therefore, a need has arisen for arrangements and methods that overcome these and other shortcomings of the related art. A technical advantage of the present invention is that portlets associated with different applications and/or created by different vendors are able to indirectly communicate with each other, e.g., share data with each other. For example, a mapping system may be used to allow portlets to communicate with each other.

According to an embodiment of the present invention, a portlet communication arrangement comprises a first portlet associated with a first application, and a second portlet associated with a second application which is different than the first application. The arrangement also comprises means for allowing the first portlet to communicate with the second portlet and for allowing the second portlet to communicate with the first portlet. For example, the means for allowing may comprise a mapping system. Specifically, the first portlet may comprise a first parameter associated with a particular type of data, the second portlet may comprise a second parameter associated with the particular type of data, and the mapping system may comprise a database comprising the first parameter, the second parameter, and a shared parameter namespace associated with the particular type of data. The mapping system also may be configured to map the first parameter and the second parameter to the shared parameter namespace to allow the first portlet to communicate with the second portlet and to allow the second portlet to communicate with the first portlet. Moreover, a content of data associated with the first parameter may be in a first format, and a content of data associated with the second parameter may be in a second format which is different than the first format. In this embodiment, the mapping system further may be configured to convert the content of the data associated with the first parameter from the first format to the second format when the first parameter is mapped to the shared parameter namespace, and to convert the content of the data associated with the second parameter from the second format to the first format when the second parameter is mapped to the shared parameter namespace.

According to another embodiment of the present invention, a portlet container, comprises a first portlet which is associated with a first application and is hosted on a particular portal page, and a second portlet associated with a second application which is different than the first application, in which the second portlet is hosted on the particular portal page. The portlet container also comprises means for allowing the first portlet to communicate with the second portlet and for allowing the second portlet to communicate with the first portlet.

According to yet another embodiment of the present invention, a software arrangement which, when executed by a processing arrangement, is configured to perform the steps of allowing a first portlet associated with a first application to communicate with a second portlet associated with a second application which is different than the first application, and allowing the second portlet to communicate with the first portlet.

According to still yet another embodiment of the present invention, a method of communicating between portlets comprises the steps of allowing a first portlet associated with a first application to communicate with a second portlet associated with a second application which is different than the first application, and allowing the second portlet to communicate with the first portlet. For example, the first portlet may comprise a first parameter associated with a particular type of data, the second portlet may comprise a second parameter associated with the particular type of data. The method further may comprise the steps of mapping the first parameter to a shared parameter namespace associated with the particular type of data, and mapping the second parameter to the shared parameter namespace to allow the first portlet to communicate with the second portlet and vice versa. Moreover, a content of data associated with the first parameter may be in a first format, and a content of data associated with the second parameter may be in a second format which is different than the first format. In this embodiment, the method also may comprise the steps of converting the content of the data associated with the first parameter from the first format to the second format when the first parameter is mapped to the shared parameter namespace, and converting the content of the data associated with the second parameter from the second format to the first format when the second parameter is mapped to the shared parameter namespace.

According to a further embodiment of the present invention, a method of managing a portlet communication arrangement within a portal comprises the steps of providing a first portlet associated with a first application, in which the first portlet comprises a first parameter associated with a particular type of data, and providing a second portlet associated with a second application which is different than the first application, in which the second portlet comprises a second parameter associated with the particular type of data. The method also comprises the steps of determining each of the first parameter and the second parameter, and generating a database comprising the first parameter, the second parameter, and a shared parameter namespace associated with the particular type of data. Moreover, the method comprises the step of mapping the first parameter and the second parameter to the shared parameter namespace to allow the first portlet to communicate with the second portlet and to allow the second portlet to communicate with the first portlet.

Other features and technical advantages of the present invention will be apparent to persons of ordinary skill in the art in view of the following detailed description of the invention and the accompanying drawings.

### BRIEF DESCRIPTION OF THE DRAWINGS

For a more complete understanding of the present invention, the needs satisfied thereby, and the features and technical advantages thereof, reference now is made to the following descriptions taken in connection with the accompanying drawings.

FIG. 1 is a schematic diagram of a portlet communication arrangement according to an embodiment of the present invention.

FIG. 2 is a flow chart of a method of managing a portlet communication arrangement within a portal according to an embodiment of the present invention.

### DETAILED DESCRIPTION OF EMBODIMENTS

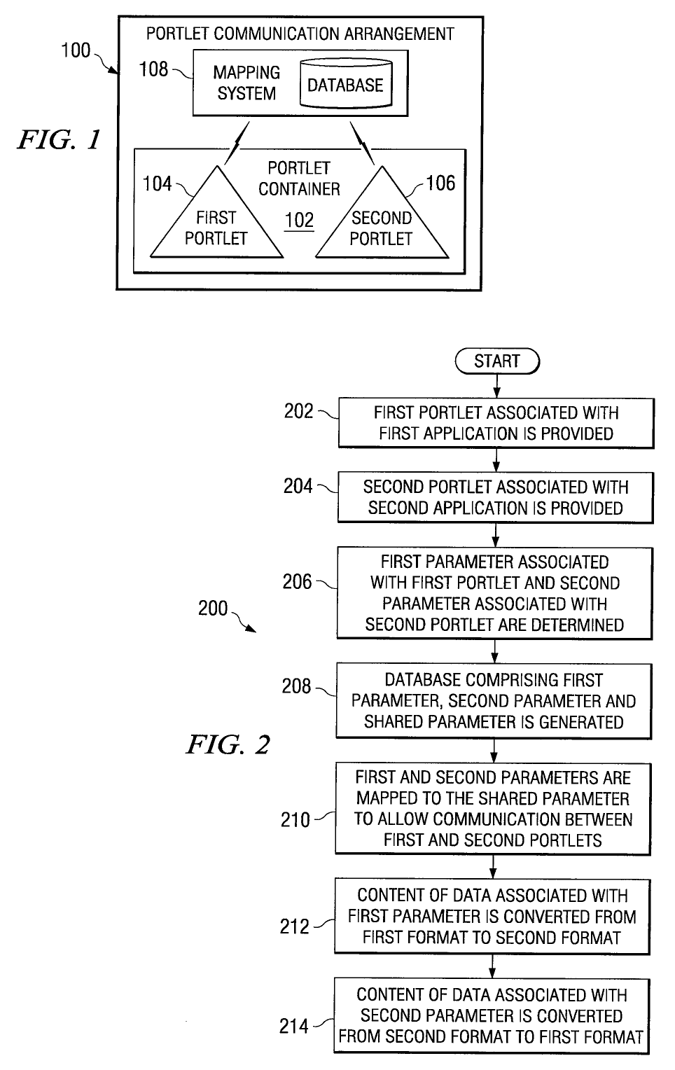

Embodiments of the present invention and their features and technical advantages may be understood by referring to FIGS. 1 and 2, like numerals being used for like corresponding parts in the various drawings.

Referring to FIG. 1, a portlet communication arrangement 100 according to an embodiment of the present invention is depicted. Portlet communication arrangement 100 may comprise a portlet container 102, a plurality of portlets, e.g., a first portlet 104 and a second portlet 106, and means for allowing the plurality of portlets to communicate with each other, e.g., a mapping system 108. For example, first portlet 104 and second portlet 106 may be aggregated within portlet container 102. In an embodiment of the present invention, first portlet 104 may be associated with a first application, second portlet 106 may be associated with a second application which is different than the first application, and first portlet 104 and second portlet 106 may be created by different portlet vendors. Although FIG. 1 merely depicts first portlet 104 and second portlet 106, those of ordinary skill in the art readily will understand that portlet communication arrangement 100 may comprise any number of portlets, and FIG. 1 depicts a pair of portlets merely for simplicity. Moreover, as shown in FIG. 1, mapping system 108 may be separate from portlet container 102, e.g., mapping system 108 may comprise software code which is separate from software code associated with portlet container 102, or alternatively, portlet container 102 may comprise mapping system 108, e.g., the software code associated with mapping system 108 may be integrated with the software code associated with portlet container 102.

Each of the plurality of portlets may comprise at least one parameter. For example, first portlet 104 may comprises a first plurality of parameters, and second portlet 106 may comprise a second plurality of parameters. Each of the plurality of parameters may be associated with a type of data. Moreover, mapping system 108 may comprise a database 110, and database 110 may comprise at least one of the first plurality of parameters and at least one of the second plurality of parameters. Database 110 also may comprise at least one shared parameter namespace. For example, when a first parameter of the first plurality of parameters is associated with a particular type of data, and a second parameter of the second plurality of parameters also is associated with the particular type of data, an administrator of mapping system 108 may create a shared parameter namespace associated with the particular type of data. Specifically, each of the first parameter of the first plurality of parameters and the first parameter of the second plurality of parameters may be mapped to the shared parameter namespace, such that the first portlet 104 and second portlet 106 may communicate with each other, e.g., by sharing data via mapping system 108.

For example, first portlet 104 may be an application which is configured to show the current stock price for a user-selected stock symbol, and second portlet 106 may be an application which is configured to show detailed stock reports. In this example, the first parameter of the first plurality of parameters and the first parameter of the second plurality of parameters each may be associated with stock prices. Nevertheless, in this example, first portlet 104 and second portlet 106 are associated with different applications, first portlet 104 and second portlet 106 may have been created by different vendors, and a parameter name associated with the first parameter of the first plurality of parameters, e.g., “ticker” may be different than a parameter name associated with the first parameter of the second plurality of parameters, e.g., “stock_id.” In order to share data associated with stock prices between first portlet 104 and second portlet 106, an administrator of mapping system 108 may create a shared parameter namespace, e.g., “stock_symbol,” and may map each of the first parameter of the first plurality of parameters and the first parameter of the second plurality of parameters to the shared parameter namespace. In this manner, first portlet 104 may communicate with second portlet 106. For example, second portlet 106 may be able to refresh and display a stock report for a stock symbol selected by a user of first portlet 104 even though first portlet 104 and second portlet 106 were not designed by their creators to communicate with each other. Moreover, those of ordinary skill in the art readily will understand that even when the parameter name of the first of the first plurality of parameters is the same as the parameter name of the first of the second plurality of parameters, first portlet 104 still cannot communicate with second portlet 106 without mapping system 108, e.g., because first portlet 104 and second portlet 106 are created by different vendors. Those of ordinary skill in the art also will readily understand that more than two portlets may be mapped to a single parameter namespace, such that more than two portlets may communicate with each other via mapping system 108.

In a modification of the above-described embodiments of the present invention, in addition to mapping various parameters to the shared parameter namespace, mapping system 108 also may be configured to convert a content of data associated with the parameters from one format to another format. For example, in the above-described examples, the content of data associated with the first of the first plurality of parameters may be in a first format, and the content of data associated with the first of the second plurality of parameters may be in a second format which is different than the first format. In operation, in order to allow second portlet 106 to more readily use data from first portlet 104, mapping system 108 may convert the content of data associated with the first of the first plurality of parameters from the first format to the second format when that parameter is mapped to the shared namespace. Similarly, in order to allow first portlet 104 to more readily use data from second portlet 106, mapping system 108 may convert the content of data associated with the first of the second plurality of parameters from the second format to the first format when that parameter is mapped to the shared namespace. Moreover, it readily will be understood by those of ordinary skill in the art that the above-described functions of mapping system 108 may be preformed by a software arrangement when the software arrangement is executed by a processing arrangement, e.g., a processor associated with a computer.

Referring to FIG. 2, a method 200 of managing portlet communication arrangement 100 within a portal according to an embodiment of the present invention is depicted. In step 202, a first portlet, e.g., first portlet 104, associated with a first application is provided. The first portlet may comprise a first parameter associated with a particular type of data, and a content of data associated with the first parameter may be in a first format. In step 204, a second portlet, e.g., second portlet 106, associated with a second application which is different than the first application is provided. The second portlet may comprise a second parameter associated with the particular type of data, and a content of data associated with the second parameter may be in a second format which is different than the first format. In step 206, an administrator of a mapping system, e.g., mapping system 108, determines each of the first parameter and the second parameter. In step 208, the administrator generates a database comprising the first parameter, the second parameter, and a shared parameter namespace associated with the particular type of data. In step 210, the administrator maps the first parameter and the second parameter to the shared parameter namespace to allow the first portlet to communicate with the second portlet and to allow the second portlet to communicate with the first portlet. In a modification of this embodiment of the present invention, in step 212, the content of the data associated with the first parameter is converted from the first format to the second format when the first parameter, and in step 214, the content of the data associated with the second parameter is converted from the second format to the first format.

While the invention has been described in connection with exemplary embodiments, it will be understood by those skilled in the art that other variations and modifications of the exemplary embodiments described above may be made without departing from the scope of the invention. Other embodiments will be apparent to those skilled in the art from a consideration of the specification or practice of the invention disclosed herein. It is intended that the specification and the described examples are considered merely as exemplary of the invention, with the true scope of the invention being indicated by the flowing claims.

What is claimed is:

1. A portlet communication arrangement, comprising:
a first portlet associated with a first application;
a second portlet associated with a second application which is different than the first application; and
means for allowing the first portlet to communicate with the second portlet and for allowing the second portlet to communicate with the first portlet.

2. The arrangement of claim 1, wherein the means for allowing comprises a mapping system.

3. The arrangement of claim 2, wherein the first portlet comprises a first parameter associated with a particular type of data, the second portlet comprises a second parameter associated with the particular type of data, and the mapping system comprises a database comprising the first parameter, the second parameter, and a shared parameter namespace associated with the particular type of data.

4. The arrangement of claim 3, wherein the mapping system is configured to map the first parameter and the second parameter to the shared parameter namespace to allow the first portlet to communicate with the second portlet and to allow the second portlet to communicate with the first portlet.

5. The arrangement of claim 4, wherein a content of data associated with the first parameter is in a first format, and a content of data associated with the second parameter is in a second format which is different than the first format, wherein the mapping system is further configured to convert the content of the data associated with the first parameter from the first format to the second format when the first parameter is mapped to the shared parameter namespace, and to convert the content of the data associated with the second parameter from the second format to the first format when the second parameter is mapped to the shared parameter namespace.

6. A portlet container, comprising:
a first portlet which is associated with a first application and is hosted on a particular portal page;
a second portlet associated with a second application which is different than the first application, wherein the second portlet is hosted on the particular portal page; and
means for allowing the first portlet to communicate with the second portlet and for allowing the second portlet to communicate with the first portlet.

7. The portlet container of claim 6, wherein the means for allowing comprises a mapping system.

8. The portlet container of claim 7, wherein the first portlet comprises a first parameter associated with a particular type of data, the second portlet comprises a second parameter associated with the particular type of data, and the mapping system comprises a database comprising the first parameter, the second parameter, and a shared parameter namespace associated with the particular type of data.

9. The portlet container of claim 8, wherein the mapping system is configured to map the first parameter and the second parameter to the shared parameter namespace.

10. The portlet container of claim 9, wherein a content of data associated with the first parameter is in a first format, and a content of data associated with the second parameter is in a second format which is different than the first format, wherein the mapping system is further configured to convert the content of the data associated with the first parameter from the first format to the second format when the first parameter is mapped to the shared parameter namespace, and to convert the content of the data associated with the second parameter from the second format to the first format when the second parameter is mapped to the shared parameter namespace.

11. A software arrangement which, when executed by a processing arrangement, is configured to perform the steps of:
allowing a first portlet associated with a first application to communicate with a second portlet associated with a second application which is different than the first application; and
allowing the second portlet to communicate with the first portlet.

12. The software arrangement of claim 11, wherein the first portlet comprises a first parameter associated with a particular type of data, and the second portlet comprises a second parameter associated with the particular type of data.

13. The software arrangement of claim 12 which, when executed by the processing arrangement, is further configured to perform the step of mapping the first parameter and the second parameter to a shared parameter namespace associated with the particular type of data to allow the first portlet to communicate with the second portlet and to allow the second portlet to communicate with the first portlet.

14. The software arrangement of claim 13, wherein a content of data associated with the first parameter is in a first format, and a content of data associated with the second parameter is in a second format which is different than the first format, wherein when executed by the processing arrangement, the software arrangement is further configured to perform the steps of:
converting the content of the data associated with the first parameter from the first format to the second format when the first parameter is mapped to the shared parameter namespace; and
converting the content of the data associated with the second parameter from the second format to the first format when the second parameter is mapped to the shared parameter namespace.

15. A method of communicating between portlets, comprising the steps of:
allowing a first portlet associated with a first application to communicate with a second portlet associated with a second application which is different than the first application; and
allowing the second portlet to communicate with the first portlet.

16. The method of claim 14, wherein the first portlet comprises a first parameter associated with a particular type of data, and the second portlet comprises a second parameter associated with the particular type of data.

17. The method of claim 16, further comprising the step of mapping the first parameter and the second parameter to a shared parameter namespace associated with the particular type of data to allow the first portlet to communicate with the second portlet and to allow the second portlet to communicate with the first portlet.

18. The method of claim 17, wherein a content of data associated with the first parameter is in a first format, and a content of data associated with the second parameter is in a second format which is different than the first format, wherein the method further comprises the steps of:
converting the content of the data associated with the first parameter from the first format to the second format when the first parameter is mapped to the shared parameter namespace; and
converting the content of the data associated with the second parameter from the second format to the first format when the second parameter is mapped to the shared parameter namespace.

19. A method of managing a portlet communication arrangement within a portal, comprising the steps of:
providing a first portlet associated with a first application, wherein the first portlet comprises a first parameter associated with a particular type of data;
providing a second portlet associated with a second application which is different than the first application, wherein the second portlet comprises a second parameter associated with the particular type of data;
determining each of the first parameter and the second parameter;
generating a database comprising the first parameter, the second parameter, and a shared parameter namespace associated with the particular type of data; and
mapping the first parameter and the second parameter to the shared parameter namespace to allow the first portlet to communicate with the second portlet and to allow the second portlet to communicate with the first portlet.

20. The method of claim 19, wherein a content of data associated with the first parameter is in a first format, and a content of data associated with the second parameter is in a second format which is different than the first format, wherein the method further comprises the steps of:
converting the content of the data associated with the first parameter from the first format to the second format when the first parameter is mapped to the shared parameter namespace; and
converting the content of the data associated with the second parameter from the second format to the first format when the second parameter is mapped to the shared parameter namespace.
